(19) United States
(12) Patent Application Publication
(10) Pub. No.: US 2008/0228715 A1
(43) Pub. Date: Sep. 18, 2008

(54) APPARATUS AND METHOD FOR DISTRIBUTED INFORMATION RETRIEVAL AND PROCESSING

(75) Inventor: Michael S. McCallister, Scottsdale, AZ (US)

Correspondence Address: MESCHKOW & GRESHAM, P.L.C., 5727 NORTH SEVENTH STREET, SUITE 409, PHOENIX, AZ, 85014, US

(73) Assignee: TERABYTE MEDIA, LLC, Scottsdale, AZ (US)

(21) Appl. No.: 11/685,030

(22) Filed: Mar. 12, 2007

(51) Int. Cl. G06F 17/30

(52) U.S. Cl. 707/3; 707/E17.108

(57) ABSTRACT

A distributed information retrieval and processing system (10) and process (100) is provided. The system (10) includes a client apparatus (20), an encoding server (30), and service providers (40). The client apparatus (20) originates (202) a primary request (21) and transmits (204) the primary request (21) to the encoding server (30) via a communication network (12). The client apparatus (20) and encoding server (30) coordinate (304) the primary request (21) over the communication network (12). The encoding server (30) encodes (316) code (32) peculiar to the primary request (21) and transmits (318) the code (32) to the client apparatus (20) via the communication network (12). The client apparatus (20) executes (214) the code (32), generates (216) secondary requests (24) in response to the code (32), and dispatches (220) the secondary requests (24) to the service providers (40) via a communication network (14). The client apparatus (20) receives (222) responses (41) to the secondary requests (24) from the service providers (40) via the communication network (14). The client apparatus (20) processes (228) the responses (41) and submits (232) the results (25) to the encoding server (30).

### TECHNICAL FIELD OF THE INVENTION

The present invention relates to the field of information retrieval. More specifically, the present invention relates to the field of distributed information retrieval and processing.

### BACKGROUND OF THE INVENTION

When it is desired to obtain information from a plurality of sources on a large communication network, such as the Internet (presumed hereinafter), a user has two basic choices. The user may search the Internet directly (a direct search). Or a third-party searcher may search the Internet for the user (an indirect search). In this context a “search” is used to mean any request for data submitted over a communication network. This request for data may involve the use of a search engine, or may be a direct request for data sent to a web site or other node on the communication network.

The majority of Internet searches are direct searches. That is, the user itself searches the Internet directly.

A direct search may be effective because the user knows best what data is being sought. This allows the user to tailor the search as required, refining the search until the desired data is obtained.

A direct search may also be effective because the computational burden of the search and costs associated therewith are placed upon the user. The user is the one desiring the data. Therefore it is only proper that the user be the one to bear the burden. Moreover, if hundreds or thousands of users were to conduct similar searches simultaneously, processing at the initiation end of the searches may be distributed throughout the hundreds or thousands of users rather than be concentrated at a single third-party searcher.

A problem may exist, however, in that a user may not be technically proficient to perform an efficient direct search. That is, the user may not know what search criteria to use to perform the search. Incorrect search criteria may lead to an unmanageable number of results. This in turn may result in the necessity of an iterative and time-consuming search procedure in order to obtain results with relevant data. This iterative search procedure may result in the expenditure of an excessive amount of time for the totality of the search, with attendant costs in terms of human time dedicated to the search.

For example, if a search is to be performed using multiple search engines or other sites, a user's lack of ability to search utilizing more than one site at a time may result in the execution of an excessive number of separate direct searches. This in turn may result in an excessive amount of time for the totality of the search.

A problem may also exist in that a user's lack of knowledge of the existence of a given search engine or other site may result in a failure to perform a direct search using that specific search engine, and a lack of relevant results from that search engine. Such missing results may result in the omission of a key piece of data and/or a misinterpretation of the data that was received.

An inefficient direct search may result in a burden upon the user in the form of excessive time required for the search over and above the time required of an efficient search. Since time spent searching in a direct search usually represents human time, i.e., time spent by a human actually performing the search, this time may have a significant associated cost. This cost, when associated with an inefficient direct search, may be significantly in excess of the cost of having an efficient indirect search performed by a third-party searcher.

In addition, an inefficient direct search may place an undue computational burden upon the user. For example, if the user were to be part of a small business with an intranet, where Internet access is granted through a common server, an inefficient search by the user may appropriate intranet resources to the point where others using the intranet suffer accordingly.

By contrast, an indirect search may be effective in that the third-party searcher may be more technically proficient than the user at performing searches, or may have automated facilities that simplify the search. This may result in a search that is quick and efficient, yielding viable data with a minimum amount of Internet access time, and also a minimal amount of human-interaction time on the part of the user.

However, if a user is unable to provide the third-party searcher with all the required data at the time of the first search, then multiple indirect searches may be required to obtain the desired data. This would be neither efficient nor cost effective.

With an indirect search, the computational burden of the search rests with the third-party searcher. A third-party searcher may contract with the user to perform the search, so the cost of this computational burden can be passed back to the user in the form of a search fee. This fee is typically over and above the cost to the user of an efficient direct search, but may be less than the overall cost of an inefficient direct search. Unfortunately, many potential users of indirect searches are reluctant to enter into such financial arrangements for a variety of reasons including the costs themselves and/or the administrative and security burdens and risks.

In order to perform efficient indirect searches, the third-party searcher needs to have processing capabilities able to support the demand for searches from multiple clients. This entails the acquisition, energizing, maintenance, and connection of an adequate number of servers to ensure sufficient processing power to support the demand along with sufficient data communication capacity with the Internet. This in turn requires significant expenditures for capital equipment, power, repair and upgrading, and Internet service provider fees on the part of the third-party searcher. In order for this type of arrangement to be economically viable, the third-party searcher should generate more revenue than is required to provide the service.

Advertising is a popular way for Internet-provided services to generate revenue due to the reduced financial, administrative and security burdens and risks for the user. But advertising often does not generate large revenues unless the ratio of users to processing capabilities is very high. Thus, many types of indirect-search applications are not fiscally viable using conventional indirect-search techniques because advertising revenues do not cover costs, and users are reluctant to enter into other financial arrangements. But, many types of indirect-search applications would be viable if the centralized processing capabilities, and attendant costs, could be considerably lessened so that realistic advertising revenues could cover costs and provide a profit, or if other financial arrangements that were perceived by users as being de minimis could be offered.

Another approach is that of using specialized client-side software to perform a direct search. This software is typically provided by a third party “searcher” that, rather than performing the search, generates software that allows the user to perform the search. This software, being specialized, permits the user to perform only those direct searches that are specifically covered by that software. Should the needs of the user change, new search software would have to generated and loaded onto the user's system. This may pose a considerable time lag between the need for a search, and the actual search itself.

Such specialized search software would also have to be obtained, learned by the user, and installed. This may significantly impact the time between the need for a search and the execution of that search. In addition, the purchase of this software may represent a considerable expense, especially when consideration is made that many versions of the software may be required to effect many different kinds of searches.

What is needed, therefore, is a search methodology that substantially achieves the benefits but does not suffer all the costs of the two approaches. That is, a search methodology that provides the benefits of efficient third-party searching but with the computational burden remaining with the user, while at the same time providing a coordination of the search criteria between the user and the third-party searcher would be desirable.

### SUMMARY OF THE INVENTION

Accordingly, it is an advantage of the present invention that an apparatus and method for distributed information retrieval and processing is provided.

It is another advantage of the present invention that a distributed information retrieval and processing system is provided that incorporates an encoding server within which a code is encoded and a client apparatus in which that code is executed.

It is another advantage of the present invention that a system and method are provided which achieve many of the advantages of centralized, indirect searching in a distributed, direct searching manner.

It is another advantage of the present invention that a system and method are provided which achieve many of the advantages of direct searching while using a centralized, indirect component.

The above and other advantages of the present invention are carried out in one form by a method of distributed information retrieval and processing, wherein the method includes the activities of originating a primary request within a client apparatus, transmitting the primary request from the client apparatus to an encoding server, encoding code peculiar to the primary request within the encoding server; transmitting the code from the encoding server to the client apparatus, executing the code in the client apparatus, generating a plurality of secondary requests within the client apparatus in response to the said executing activity, dispatching the plurality of secondary requests to a plurality of service providers in response to the executing activity, and receiving a plurality of responses from the plurality of service providers in response to the executing activity.

The above and other advantages of the present invention are carried out in another form by a system of distributed information retrieval and processing, wherein the system includes a client apparatus configured to originate a primary request, transmit the primary request, receive code peculiar to the primary request, execute the code, generate a plurality of secondary requests in response to the code, dispatch the plurality of secondary requests in response to the code, and receive a plurality of responses to the plurality of secondary requests in response to the code, an encoding server configured to receive the primary request from the client apparatus, encode the code peculiar to the primary request, and transmit the code to the client apparatus, and a plurality of service providers configured to receive the plurality of secondary requests from the client apparatus, generate the plurality of responses in responses to the plurality of secondary requests, and transmit the plurality of responses to the client apparatus.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram depicting a first portion of a distributed information retrieval and processing system and process of operation in accordance with a preferred embodiment of the present invention;

FIG. 2 shows a block diagram depicting a second portion of the system and process of FIG. 1 in accordance with a preferred embodiment of the present invention; and

FIG. 3 shows a block diagram depicting a third portion of the system and process of FIG. 1 in accordance with a preferred embodiment of the present invention.

### DETAILED DESCRIPTION OF THE PREFERRED EMBODIMENTS

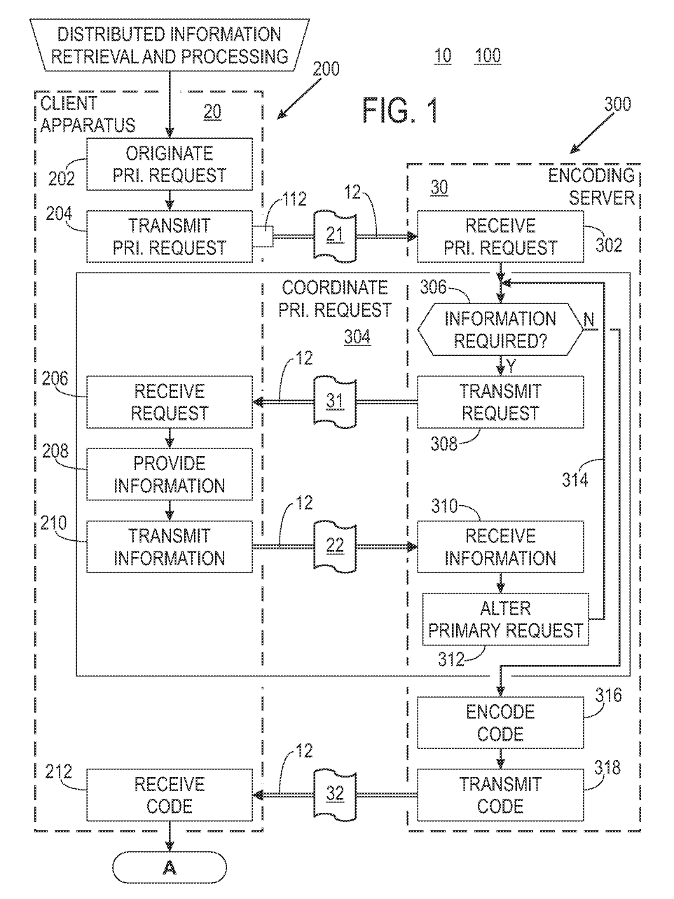

FIGS. 1, 2, and 3 together show a block diagram depicting a distributed information retrieval and processing system 10 and process 100 in accordance with a preferred embodiment of the present invention. The following discussion refers to FIGS. 1, 2, and 3.

Distributed information retrieval and processing system 10 is made up of a client apparatus 20, an encoding server 30, and at least one service provider 40. Client apparatus 20, encoding server 30, and service providers 40 are information processing devices such as general purpose computers, personal computers, desktop computers, workstations, laptop computers, handheld computers, cell phones, portable audio devices, and the like, or networks of such devices, which are capable of connecting to a communication network (discussed hereinafter), such as the Internet. Encoding server 30 and service providers 40 may each typically have more processing capabilities than client apparatuses 20, but this is not a requirement of the present invention. Each of client apparatuses 20, encoding server 30, and service providers 40 may provide other functions in addition to the ones discussed herein. The inclusion of such other functions is not germane to the present invention, and is not discussed herein.

Client apparatus 20 is a programmable information processing device. That is, client apparatus 20 is capable of accepting and executing code (discussed hereinafter). Client apparatus 20 is also capable of connecting to and communicating with a communication network (discussed hereinafter). Client apparatus 20 incorporates a network communication program (e.g., an Internet browser) with which it communicates with the communication network to which it is configured to electronically couple. It will be appreciated by those skilled in the art that the form client apparatus 20 may take is not germane to the present invention.

Encoding server 30 is an information processing device electronically connected to a communication network (discussed hereinafter), e.g., an Internet web site. Encoding server 30 is configured to receive a request from client apparatus 20 via the communication network, process the request in an appropriate manner, and return data in response to the request to client apparatus 20 via the communication network.

Service providers 40 are computer servers or other information processing devices electronically connected to a communication network (discussed hereinafter), e.g., Internet web sites. Service providers 40 are configured to receive requests from client apparatus 20 via the communication network, process the requests in appropriate manners, and return responses to the requests to client apparatus 20 via the communication network. In general, when the communication network is provided by the Internet, service providers 40 reside in different Internet domains from each other and in different Internet domains from encoding server 30, but that is not a requirement of the present invention.

Client apparatus 20 is configured to couple to a communication network 12, and via communication network 12 to encoding server 30. Communication network 12 is desirably the Internet. Similarly, client apparatus 20 is configured to couple to a communication network 14, and via communication network 14 to each service provider 40. Communication network 14 is also desirably the Internet.

Communication networks 12 and 14 are desirably components of one and the same network. That network is desirably the Internet. By having communication networks 12 and 14 realized as components of the same communication network, a maximum of flexibility and utility is achieved for system 10. It will be appreciated by those skilled in the art, however, that this is not a requirement of the present invention. Communication networks 12 and 14 may be realized as entirely different networks. For example, either or both of communication networks 12 or 14 may be realized as a privately owned network or intranet. This ability to be different networks is emphasized in this discussion through the use of different reference numbers for communication networks 12 and 14. It will be appreciated that embodiments in which communication networks 12 and 14 are different networks, and where either or neither of communication networks 12 or 14 is the Internet, may be realized without departing from the spirit of the present invention.

In the preferred embodiment, client apparatus 20, common to both communication networks 12 and 14, does not serve as a hub or other portal through which encoding server 30 and service providers 40 communicate with each other. Also, when communication networks 12 and 14 are realized as components of the same network, e.g., the Internet, it is not a requirement of the present invention that encoding server 30 and service providers 40 couple to and communicate with each other via communication networks 12 and 14.

Encoding server 30 is a network server or other device configured to communicate and coordinate with client apparatus 20 via communication network 12. Client apparatus 20 is a client of encoding server 30. Encoding server 30 may have any number of clients, i.e., may communicate and coordinate with any number of client apparatuses 20. The potential for revenue by encoding server 30 increases as the number of clients (i.e., contracting client apparatuses 20) increases. A large number of clients results in a low capital expenditure per client, and allows encoding server 30 to generate a reasonable profit. Techniques known to those skilled in the art for generating revenues, such as selling advertising and/or contractual arrangements with users of client apparatuses 20, may be used by encoding server 30.

Those skilled in the art will appreciate, however, that the actual number of client apparatuses 20 with which encoding server 30 communicates and coordinates is not germane to the present invention.

Encoding server 30 is configured to design a search methodology for client apparatus 20, and to express that designed search methodology in the form of computer-executable software, referred to hereinafter as “code.” More specifically, encoding server 30 is configured to process a request for data, encode code (discussed hereinafter) peculiar to that request, and pass that code back to client apparatus 20 for execution. In the preferred embodiment, encoding server 30 neither executes the code it encodes, nor obtains any portion of the requested data for client apparatus 20 during normal operations.

Each service provider 40 is a computer server or other device at a location on communication network 14 which has or may develop the data requested of encoding server 30 by client apparatus 20. The number of service providers 40 merged into and accessed by system 10 varies depending upon the nature of the request made of encoding server 30 by client apparatus 20. Although system 10 may have only one service provider 40 in response to a specific request, this is considered a trivial and unusual circumstance. The potential of system 10 is more fully realized as the number of service providers 40 increases.

In the preferred embodiment, a given service provider 40 is an Internet web site accessed through a Uniform Resource Locator (URL), which serves as an address for that service provider. That given service provider 40 may be realized as a single computer server or other device, or may be realized as a plurality of such servers or devices, often hundreds or thousands, connected together so as to share a common URL. Those skilled in the art will appreciate that the implementation of any given service provider 40 is not germane to the present invention.

Through process 100 (discussed hereinafter), client apparatus 20 submits a primary request 21 to encoding server 30, encoding server 30 generates code (discussed hereinafter) peculiar to that primary request 21, client apparatus 20 executes that code to generate and dispatch secondary requests to service providers 40 (i.e., executes direct searches), and service providers 40 return responses (discussed hereinafter) for those direct searches to client apparatus 20. This places the methodology of the searches upon encoding server 30, but places the actual burden of executing the searches upon client apparatus 20. This reduces significantly the computational overhead required of encoding server 30, allowing for a cost-effective and efficient physical embodiment thereof. As will be appreciated by those of ordinary skill in the art, this scenario is most efficient when encoding server 30 serves a significant number of client apparatuses 20, each of which directly searches a significant number of service providers 40 when executing the code encoded by encoding server 30.

System 10 is operated through distributed information retrieval and processing process 100. Process 100 may broadly be divided into three subprocesses: a client-apparatus subprocess 200; an encoding-server operation subprocess 300; and a service-provider operation subprocess 400.

Client-apparatus operation subprocess 200 is made up of all tasks in process 100 that are carried out within and/or by client apparatus 20. For convenience, each task in subprocess 200 has a reference number in the range of 201-299.

Encoding-server operation subprocess 300 is made up of all tasks in process 100 that are carried out within and/or by encoding server 30. For convenience, each task in subprocess 300 has a reference number in the range of 301-399.

Service-provider operation subprocess 400 is made up of all tasks in process 100 that are carried out within and/or by a service provider 40. For convenience, each task in subprocess 400 has a reference number in the range of 401-499.

Not shown in the Figures, process 100 may begin with client apparatus 20 effecting one or more preliminary requests, and receiving responses from, encoding server 30. These preliminary requests serve to establish communication and exchange any necessary preliminary data between client apparatus 20 and encoding server 30 via communication network 12. The use of such preliminary requests is well known to those skilled in the art, and shall be taken as granted in this discussion. However, such preliminary requests are not a requirement of the present invention.

In the preferred embodiment, communication network 12 is realized as the Internet, and communication between client apparatus 20 and encoding server 30 uses a standard Transmission Control Protocol over Internet Protocol (TCP/IP) format, and more specifically a “Hypertext Transfer Protocol” (HTTP) or a “Hypertext Transfer Protocol, Secure” (HTTPS), well-known to those of ordinary skill in the art. It will be appreciated, however, that this is not a requirement of the present invention. Other communication networks and/or protocols may be used without departing from the spirit of the present invention.

Process 100 continues with a task 202, in which client apparatus 20 originates primary request 21. A task 204 then transmits primary request 21 to encoding server 30 via communication network 12. Request 21 is a “primary” request only in that it comes before “secondary” requests (discussed hereinafter).

Primary request 21 may be originated in any of a number of different manners well known to those of ordinary skill in the art. In one embodiment, primary request 21 may consist of a preferably on-line search-request form (not shown) originated (filled out) by an operator of client apparatus 20 in task 202 and transmitted to encoding server 30, preferably via communication network 12 in task 204.

Those skilled in the art will appreciate that the present invention is not limited to any specific methodology for the origination of primary request 21. Any of a multiplicity of methodologies may be used to originate primary request 21 without departing from the spirit of the present invention.

To demonstrate the operation of process 100 upon a preferred embodiment of system 10, an example is presented in which a user of client apparatus 20 has a web site and wishes to know the ranking of that web site on the Internet. To avoid confusion with direct task descriptions and/or other examples, each portion of this example is indicated hereinafter by the phrase “in the site-ranking example” at the beginning of each relevant paragraph. Those skilled in the art will appreciate that the present invention is not limited to this example. This example is but one of a multiplicity of possible applications of system 10 and process 100 therefor.

In the site-ranking example, the user wishes to know where the web site ranks in relation to other, similar web sites in the results of various search engines using various key phrases for the search. This knowledge is desirable because sites that have good rankings for various search-engine key phrases are more likely to be accessed than sites with poor rankings. Access of a web site is equivalent to a customer walking into a retail establishment. The more accesses a given site has, the more likely it is to produce revenue. With knowledge of the ranking of his/her web site, the user may alter that web site to increase its ranking, thereby increasing the number of times it is accessed.

In the site-ranking example, The user causes client apparatus 20 to execute process 100 and originate primary request 21 in task 202. The user accomplishes this by filling out a search-request form. This form contains instructions to utilize a plurality of different key phrases, to submit those key phrases to each of as many search engines as possible, and to tabulate the results. Task 204 transmits this search-request form, as primary request 21, to encoding server 30 via communication network 12 (the Internet).

Within encoding server 30, a task 302 receives primary request 21. It will be appreciated that for task 204 to transmit and task 302 to receive primary request 21, client apparatus 20 and encoding server 30 needs be coupled via communication network 12. This is accomplished through a task 112, depicted in FIG. 1 as a small box between task 204 and an accented arrow symbolizing first communication network 12.

Following task 302, encoding server 30 coordinates with client apparatus 20 in a hypertask 304. “Coordinate” is defined herein as determining if any required information 22 is absent from primary request 21, and, when required information 22 is absent, obtaining that required information 22 from client apparatus 20 and altering primary request 21 accordingly.

Required information 22 is any information required by encoding server 30 to properly process primary request 21, i.e., to encode code (discussed hereinafter) peculiar to primary request 21. For example, if primary request 21 is a search-request form, required portions of that form may have been left blank or improperly completed. Required information 22 might then be the data that was omitted from or improperly entered into that search-request form.

Alternatively, information 22 may be information required to refine the search criteria to produce an efficient search. For example, if primary request 21 were for data on camera lenses, required information 22 may be the make and model of camera, the lens mount, the focal length, etc.

In a query task 306, encoding server 30 determines if information 22 is required. If query task 306 determines that information 22 is not required, then encoding server 30 has all the data it needs to continue. Coordinating hypertask 304 is completed.

If query task 306 determines that information 22 is required, then in a task 308 encoding server 30 transmits an information request 31 to client apparatus 20 via communication network 12. In a task 206, client apparatus 20 receives information request 31.

It will be appreciated that, in the preferred embodiment where communication network 12 is the Internet, and where TCP/IP protocols, realized as HTTP or HTTPS protocols, are used, encoding server 30 does not normally make a request of client apparatus 20. Rather, client apparatus 20 makes requests of encoding server 30, which can only respond to those requests. From a human point of view, however, that response may (and often does) take the form of a “request.” Information request 31 is such a response in the form of a request.

In response to information request 31, client apparatus 20 provides required information 22 in a task 208 and transmits required information 22 to coordination server 30 via communication network 12 in a task 210.

Task 208 may be performed interactively with the user. The user may be prompted for required information 22 using any of a plurality of data output techniques well known to those skilled in the art. The user may then provide required information 22 using any of a plurality of data input techniques well known to those skilled in the art. For example, if primary request 21 is a search-request form, information request 31 may be of the “box nn left blank” variety. In this case, the user would enter required information 22 in the appropriate box of the search-request form. Task 210 would then essentially be a resubmission of primary request 21 with required information 22 included therein.

Alternatively, required information 22 may be provided automatically by client apparatus 20. For example, required information 22 may be an identification code or other information contained within client apparatus 20 that may be required by encoding server 30. Client apparatus 20 may be configured to automatically provide such information upon request without an overt action on the part of the user.

Those skilled in the art will appreciate that the specific methodology of tasks 208 and 210 to obtain required information 22 is not germane to the present invention. Any of a multiplicity of well-known methodologies may be used without departing from the spirit of the present invention.

Encoding server 30 receives required information 22 in a task 310 and alters primary request 21 as required to incorporate required information 22 in a task 312. Process 100 then loops back to query task 306 in an iteration pseudotask 314.

In query task 306, encoding server 30 determines if further information 22 is required. If query task 306 determines that further information 22 is not required, then encoding server 30 has all the data it needs to continue. Coordinating hypertask 304 is completed.

If query task 306 determines further information 22 is required, then tasks 308, 206, 208, 210, 310, and 312 within pseudotask 314, are iterated. This continues until query task 306 determines that further information 22 is not required and coordinating hypertask 304 is completed. Of course, those skilled in the art will appreciate that conventional error-handling techniques (not shown) may also be used here and elsewhere in process 100 to prevent the establishment of infinite loops, to time-out non-responsive targets of requests, and the like.

Those skilled in the art will appreciate that, while task 312 to alter primary request 21 is depicted as being performed in each iteration, this is not a requirement of the present invention. Task 312 may be singly effected after all required information 22 has been accumulated without departing from the spirit of the present invention.

In the site-ranking example, encoding server 30 executes hypertask 304 to coordinate primary request 21 with client apparatus 20 and obtain any additional required information 22. Perhaps the user omitted an important datum or misspelled a key phrase in primary request 21, or perhaps encoding server 30 may suggest adding other key phrases that the user did not initially consider. If hypertask 304 obtained any additional required information 22, then primary request 21 is altered to include required information 22 by task 312.

Once encoding server 30 has coordinated primary request 21 with client apparatus 20, i.e., upon completion of coordinating hypertask 304, a task 316 encodes code 32 in encoding server 30. In other words, task 316 automatically generates computer software, computer programming, programming, instructions, and/or the like, as appropriate to carry out an effective and efficient search. In short, encoding server 30 defines a search methodology that will be carried out by the requesting client apparatus 20, and that search methodology is expressed by code 32. The precise nature of code 32 and its configuration is dependent upon the nature of the search methodology being carried out.

Those skilled in the art will appreciate that the form and distribution of code 32 is not germane to the present invention. That is, code 32 may consist of a complete code 32 encoded in task 316, or may consist only of a request-peculiar portion of code 32 generated in task 316 that will, when executed, make use of a library of other code portions contained in client apparatus 20, or perhaps uploaded to client apparatus 20 from encoding server 30 during the preliminary request portion of process 100 (discussed hereinbefore). The use of a complete code 32, a request-peculiar code 32 for use with a code library, or other embodiment of code 32 does not depart from the spirit of the present invention.

Code 32 is code configured to execute (discussed hereinafter) upon client apparatus 20 to generate and dispatch secondary requests (discussed hereinafter) to service providers 40. In the preferred embodiment, code 32 is encoded in ECMAScript (European Computer Manufacturers Association Script), also referred to as JavaScript, a cross-platform scripting embedded language configured to run in web browsers. This allows a web browser 23 within client apparatus 20 to execute code 32 (discussed hereinafter). Those skilled in the art will appreciate that encoding code 32 in ECMAScript is not a requirement of the present invention. Other languages may be used without departing from the spirit of the present invention.

In the preferred embodiment, process 100 operates in a cross-domain environment, i.e., across multiple Internet domains. An “Internet domain,” as defined herein, is an identification of a computer (or a plurality of computers) on the Internet, which identification is a part of that computer's URL, and is the product provided by domain name registrars. In the preferred embodiment, encoding server 30, which has one Internet domain, generates code 32 to be executed on client apparatus 20 to retrieve send requests to and retrieve responses from (discussed hereinafter) service providers 40, which have other Internet domains. Those skilled in the art will appreciate that this cross-domain environment is not a requirement of the present invention. The use of a single-domain environment does not depart from the spirit of the present invention.

Once task 316 has encoded code 32, a task 318 then transmits code 32 to client apparatus 20 via communication network 12. Client apparatus 20 receives code 32 in a task 212.

In the site-ranking example, task 316 encodes code 32 in ECMAScript within encoding server 30. Code 32 is peculiar to primary request 21, i.e., code 32 is configured so that, when executed in web browser 23 within client apparatus 20, code 32 will at minimum cause client apparatus to perform a direct search meeting the condition presented in primary request 21 as altered in coordinating hypertask 304 (if so altered). In general, code 32 will include uniform resource locators (URL's) of various search engines known to encoding server 30. This constitutes a cross-domain environment for the operation of system 10, where client apparatus 20, on one internet domain, obtains code 32 from encoding server, on another Internet domain. Code 32, when executed in client apparatus 20 (discussed hereinafter), makes requests of and obtains responses from (discussed hereinafter) service provides, on yet other Internet domains.

In the site-ranking example, code 32 will include various search terms to apply at the web sites denoted by the URL's. Code 32 will instruct client apparatus 20 how to format a number of direct searches--quite possibly a large number of direct searches. Code 32 will instruct client apparatus 20 to dispatch the direct searches over communication network 14, preferably with multiple direct searches taking place simultaneously. And code 32 will instruct client apparatus 20 what to do with results (discussed hereinafter) returned from service providers 40 in response to the direct searches. Task 318 then transmits code 32 from encoding server 30 to client apparatus 20 via communication network 12. Code 32 is received at client apparatus 20 in task 212.

While not shown in the Figures, those skilled in the art will appreciate that, once code 32 has been received by client apparatus 20 in task 212, the coupling (task 112) between client apparatus 20 and encoding server 30 via communication network 12 may be severed.

Code 32 is peculiar to primary request 21 as submitted by client apparatus 20. That is, code 32 may be different for each unique primary request 21 submitted to encoding server 30. In circumstances where coordinating hypertask 304 results in primary request 21 being altered by task 312, then code 32 is peculiar to primary request 21 as submitted by client apparatus 20 and altered by encoding server 30.

Code 32 is executed in client apparatus 20 by a task 214. In the preferred embodiment, code 32 is encoded in ECMAScript, and is executed by web browser 23 within client apparatus 20. Web browser 23 is a program, (e.g., Internet Explorer® from Microsoft Corporation, or Firefox® from Mozilla Foundation) which allows a user to, among other things, read hypertext and execute a scripted language, e.g., code 32 encoded in ECMAScript. The use of web browser 23 in client apparatus 20, and the customizing of web browser 23 by the inclusion of code 32 is desirable in that users are often already familiar with their web browsers, and any learning curve associated with code 32, when combined into the web browser, is lessened when compared to stand-alone code a user might need to learn to use from scratch.

In the preferred embodiment, code 32 is hypercode. That is, code 32 is made up of one or more self-contained codes. The primary one of these codes is realized as a request manager 33. Request manager 33 is executed within client apparatus 20 in task 214.

In the site-ranking example, task 214 executes code 32, i.e., request manager 33, within client apparatus 20. Encoding server 30 encodes or generates code 32, but does not execute code 32 during normal operation. The execution of code 32 is assumed by client apparatus 20. If the execution of code 32 results in a lengthy or complex process, it is client apparatus 20 which assumes the computational burden for that process. When multiple client apparatuses 20 simultaneously execute their own peculiar codes 32, the combined computational burden for those processes is distributed among the multiple client apparatuses 20.

In a task 216, the execution of code 32 generates at least one secondary request 24. In other words, one of the characteristics of code 32 encoded by encoding server 30 in task 316 is to cause client apparatus 20, when client apparatus 20 executes code 32, to generate at least one secondary request 24.

In the preferred embodiment, communication network 14 is the Internet. In this embodiment, secondary request 24 is a hypertext transfer protocol (http) request configured to be submitted to an Internet-based service provider 40. Those skilled in the art will appreciate, however, that this is not a requirement of the present invention. Similarly, at least one secondary request 24 is generated for each service provider 40 to be accessed.

The identities of service providers 40 are encoded into code 32 by encoding server 30. It is a responsibility of encoding server 30 to maintain a comprehensive list of the identities of service providers 40, i.e., all search engines, that may be relevant to any client apparatus 20 contracting with encoding server 30. This removes the burden of knowing which search engines exist and which to use for a given search from the user of client apparatus 20. This allows for efficient direct searches by client apparatus 20 without empirical knowledge of where and how to search on the part of the user.

It will be appreciated that the generation of only a single secondary request 24 is considered a trivial and unusual circumstance. Considering the number of service providers 40 available and the probability of multiple searches per service provider 40 per primary request 21, then the generation of only a single secondary request 24 into code 32 would be unusual. This discussion therefore presumes the generation of a hyper-plurality of secondary requests 24, where a plurality of secondary requests 24 will be dispatched to each of a plurality of service providers 40.

Secondary requests 24 are queued in a task 218 and dispatched (transmitted), at least one secondary request 24 to each service provider 40, in a task 220. Task 220 may dispatch any number of secondary requests 24 substantially simultaneously, at least from the perspective of human perception. Since the dispatching of secondary requests 24 to service providers 40 normally results in responses (discussed hereinafter) from service providers 40, it is desirable that order and control be maintained within the computational capabilities of client apparatus 20. It is the purpose of queuing task 218 to establish and maintain this order and control.

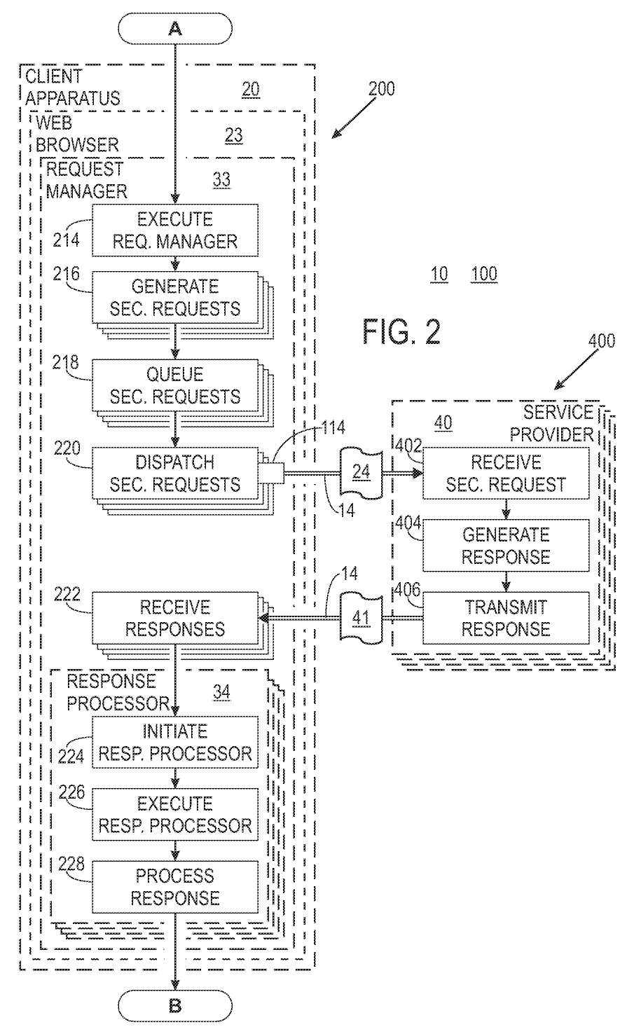

Task 220 dispatches (transmits) each secondary request 24 from client apparatus 20 to a specific service provider 40, where secondary request 24 is received in a task 402. It will be appreciated that for task 220 to transmit and task 402 to receive secondary request 24, client apparatus 20 and that given service provider 40 needs to be coupled via communication network 14. This is accomplished through a task 114, depicted in FIG. 2 as a small box between task 220 and an accented arrow symbolizing communication network 14. Each service provider 40 is coupled to client apparatus 20 by a task 220.

In the site-ranking example, the execution of code 32 in task 216 generates a plurality of secondary requests 24. Each of secondary requests 24 is an http request for a specific service provider 40 (search engine) to determine the ranking of the user's web site on that search engine in response to a specific key phrase. Secondary requests 24 are queued in task 218 and dispatched to service providers 40 via communication network 14, which is also the Internet.

In the site-ranking example, each service provider 40 represents a server, or plurality of servers, on the Internet having a single URL and hosting a specific search engine. When generating code 32, encoding server 30 was able to include Internet addresses for more service providers 40 (i.e., search engines) than it would be reasonable for the user to access directly. This provides a significant improvement in search time to obtain the desired data.

Within each service provider 40, a task 404 generates response 41 based upon the processing of secondary request 24 within that service provider 40. A task 406 then transmits response 41 to client apparatus 20 via communication network 14. Response 41 is received in client apparatus 20 by a task 222.

While not shown in the Figures, those skilled in the art will appreciate that, once response 41 has been received by client apparatus 20 from a given service provider 40, the coupling (task 114) between client apparatus 20 and that service provider 40 via communication network 14 may be severed.

In the site-ranking example, each service provider 40 receives at least one secondary request 24 for each key phrase. In task 404, each individual service provider 40 generates a response 41 to each secondary request 24 received by that service provider 40. Response 41 contains, among other possible data, the ranking of the user's web site on that search engine for that key phrase or data that may be processed to determine a ranking. A task 406 transmits each response 41 to client apparatus 20.

In some embodiments, the receipt of responses 41 by client apparatus 20 may terminate process 100. Those skilled in the art will appreciate that this is not a requirement of and does not depart from the spirit of the present invention.

In the preferred embodiment of the Figures, within or in addition to request manager 33, code 32 includes another self-contained code realized as a response processor 34. Unlike request manager 33, response processor 34 is not self-starting within client apparatus 20. Therefore, at the appropriate time, i.e., when at least one response 41 has been received from at least one service provider 40, code 32 (i.e., request manager 33) executes a task 224 within process 100 that initiates an instance of response processor 34. Process 100 then executes response processor 34 in a task 226.

In the preferred embodiment, response processor 34 is initiated and executed a plurality of times, at least once for each response 41 received by client apparatus 20. Those skilled in the art will appreciate that this is not a requirement of the present invention. Alternative embodiments wherein response processor 34 is initiated and/or executed fewer times than the number of received responses 41 do not depart from the spirit of the present invention.

The execution of response processor 34 in task 226 results in each response 41 being processed in a task 228 peculiar to both the service provider 40 originating that response 41, and peculiar to client apparatus 20. Multiple ones of service providers 40 may provide responses 41 which need be processed in substantially identical manners, or may provide responses 41 that need be processed in significantly different manners. This preliminary portion of task 228 results in responses 41 that are substantially identical in format (not shown). These substantially identically formatted responses 41 are then further processed in task 228 in a manner peculiar to client apparatus 20. That is, differing client apparatuses 20 may process responses 41 in different ways. The processing of responses 41 produces processed responses 25.

In the site-ranking example, for even a relatively few key phrases and a relatively few service providers 40, process 100 dispatches a significant number of secondary requests 24 and receives a significant number of responses 41. This significant number of responses 41 often contains the desired data (the rankings) buried amongst a plethora of other data. In task 228, response processor 34 processes responses 41. This processing may consist of tabulating the desired data and discarding all other data in responses 41.

In some embodiments, the processing of responses 41 in task 228 may terminate process 100. Those skilled in the art will appreciate that this is not a requirement of and does not depart from the spirit of the present invention.

Hereinafter in this discussion, it will be presumed that task 228 has processed responses 41 and produced processed responses 25. While not shown in the Figures, those skilled in the art will appreciate that, in an alternative embodiment, it may be (unprocessed) responses 41 rather than processed responses 25 that may be involved in each task subsequent to task 228 that involves processed responses 25. The term “response(s) 25” used subsequently herein should be taken to indicate either “response(s) 41” or “processed response(s) 25.”

In the preferred embodiment of the Figures, a query task 230 in process 100 determines if responses 25 are to be submitted to encoding server 30. If query task 230 determines that responses 25 are to be submitted, then in a task 232 responses 25 are submitted (transmitted) to encoding server 30, where they are received in a task 320. Once in encoding server 30, responses 25 may be further processed in a manner peculiar to encoding server 30 and beyond the scope of the present invention.

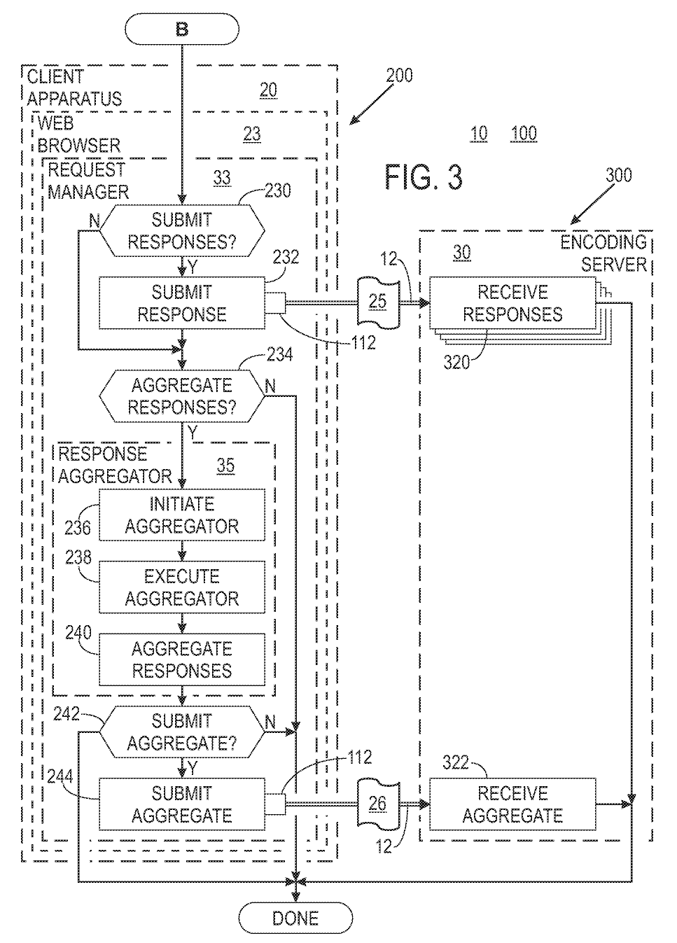

Within encoding server 30, a task 320 receives responses 25. It will be appreciated that for task 232 to submit (transmit) and task 320 to receive responses 25, client apparatus 20 and encoding server 30 needs be coupled via communication network 12. If the coupling between client apparatus 20 and encoding server 30 was severed after task 212 (discussed hereinbefore), then they may be re-coupled by a repetition of task 112, depicted in FIG. 3 as a small box between task 232 and an accented arrow symbolizing communication network 12. Once all responses 25 have been received by encoding server 30, the coupling between client apparatus 20 and encoding server 30 via communication network 12 may be severed.

In some embodiments, the submission of responses 25 in task 232 may terminate process 100. Those skilled in the art will appreciate that this is not a requirement of and does not depart from the spirit of the present invention.

In the preferred embodiment of the Figures, following task 232 or if query task 230 determines that responses 25 are not to be submitted, then a query task 234 in process 100 determines if responses 25 are to be aggregated to form an aggregate response 26.

In the preferred embodiment of the Figures, within or in addition to request manager 33, code 32 also includes another self-contained code realized as a response aggregator 35. Unlike request manager 33, response aggregator 35 is not self-starting within client apparatus 20. Therefore, at the appropriate time, i.e., when query task 234 has determined that responses 25 are to be aggregated, code 32 (i.e., request manager 33) executes a task 236 within process 100 that initiates response aggregator 35. Process 100 then executes response aggregator 35 in a task 238. The execution of response aggregator 35 in task 238 results in responses 25 being aggregated in a task 240 to produce aggregated response 26.

Since a plurality of secondary requests 24 was most likely submitted to each service provider 40, a plurality of responses 41 was most likely received from each service provider 40. This plurality of responses 41 from each service provider 40 may be aggregated into a single aggregate response 26 by aggregation task 240. “Aggregate,” as used herein, means to aggregate, concatenate, or combine responses 41. Therefore, in one embodiment each aggregate response 26 contains an aggregation, concatenation, or combination of the relevant data from each processed response 25 for that service provider 40. In another embodiment, aggregate response 26 aggregates relevant data over all service providers 40.

In the site-ranking example, task 240, in response to the execution of response aggregator 35 in task 238, aggregates, concatenates, and/or combines responses 41 from each service provider 40 to produce an aggregate response 26 relevant to that service provider 40. Aggregate response 26 may, for example, provide statistics that characterize one or more significant chunks of the relevant data from all responses 25.

Furthermore, while not shown in the Figures, aggregation task 240 may further aggregate the aggregate responses 26 for each service provider 40 into a single aggregate response 26 for all service providers 40. Those skilled in the art will appreciate, however, that this is not a requirement of the present invention.

In the site-ranking example, task 240 additionally aggregates the responses 25 from each service provider 40 into an aggregate response 26 for all service providers 40 combined. In this manner, aggregate response 26 not only contains data relevant to each service provider 40, but a summary or composite of that data relevant to the search as a whole.

Also, in some embodiments, the aggregating of responses 25 in task 240 may terminate process 100. Those skilled in the art will appreciate that this is not a requirement of and does not depart from the spirit of the present invention.

In the preferred embodiment of the Figures, a query task 242 in process 100 determines if aggregated response 26 is to be submitted to encoding server 30. If query task 242 determines that aggregated response 26 is to be submitted, then in a task 244 aggregate response 26 is submitted (transmitted) to encoding server 30, where it is received in a task 322. Once in encoding server 30, aggregate response 26 may be further processed in a manner peculiar to encoding server 30 and beyond the scope of the present invention.

Within encoding server 30, task 322 receives aggregate response 26. It will be appreciated that for task 244 to submit (transmit) and task 322 to receive aggregate response 26, client apparatus 20 and encoding server 30 needs be coupled via communication network 12. If the coupling between client apparatus 20 and encoding server 30 was severed after task 212 (discussed hereinbefore), then they may be re-coupled by a repetition of task 112, depicted in FIG. 3 as a small box between task 244 and an accented arrow symbolizing communication network 12. Once aggregate response 26 has been received by encoding server 30, the coupling between client apparatus 20 and encoding server 30 via communication network 12 may be severed.

In the site-ranking example, task 244 submits aggregate response 26 from client apparatus 20 to encoding server 30 via communication network 12. Aggregate response 26 is received at encoding server 30 in task 322. In this manner, the ranking of the user's web site is added to a database for client apparatus 20 within encoding server 30. This allows encoding server 30 to indicate to the user, over time, changes in the ranking of the user's web site on the Internet.

In the preferred embodiment of the Figures, the submission of aggregate response 26 in task 232 terminates process 100.

In summary, the present invention teaches a system 10 and process 100 for distributed information retrieval and processing. System 10 incorporates an encoding server 30 within which a code 32 is encoded and a client apparatus 20 in which code 32 is executed. Client apparatus 20 originates a primary request 21, coordinates primary request 21 with encoding server 30, receives code 32 encoded within encoding server 30 in response to primary request 21, executes code 32, generates secondary requests 24 in response to the execution of code 32, dispatches secondary requests 24 to service providers 40, and receives responses 41 from service providers 40.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A method of distributed information retrieval and processing, said method comprising:
a) originating a primary request within a client apparatus;
b) transmitting said primary request from said client apparatus to an encoding server;
c) encoding code peculiar to said primary request within said encoding server;
d) transmitting said code from said encoding server to said client apparatus;
e) executing said code in said client apparatus;
f) generating a plurality of secondary requests within said client apparatus in response to said executing e) activity;
g) dispatching said plurality of secondary requests to a plurality of service providers in response to said executing e) activity; and
h) receiving a plurality of responses from said plurality of service providers in response to said executing e) activity.

2. A method as claimed in claim 1 wherein:
said method additionally comprises:
coupling said client apparatus to said encoding server via a communication network;
coupling said client apparatus to said plurality of service providers via said communication network;
said transmitting b) and transmitting d) activities are effected via said communication network; and
said dispatching g) and receiving h) activities are effected via said communication network.

3. A method as claimed in claim 2 wherein said communication network is the Internet.

4. A method as claimed in claim 3 wherein:
said encoding server has a first domain on the Internet; and
said plurality of service providers have a plurality of second domains on the Internet, wherein each of said second domains differs from said first domain.

5. A method as claimed in claim 1 additionally comprising coordinating said primary request within said encoding server.

6. A method as claimed in claim 5 wherein said coordinating activity comprises:
determining if said originating a) activity failed to provide said primary request with information required of said encoding c) activity;
providing said encoding server with said information when said determining activity determines that said originating a) activity failed to provide said information; and
altering said primary request in response to said providing activity.

7. A method as claimed in claim 6 wherein said coordinating activity additionally comprises iterating said determining, providing, and altering activities until said determining activity determines said information is not required.

8. A method as claimed in claim 1 wherein:
said encoding c) activity encodes said code in ECMAScript within said encoding server; and
said executing e) activity executes said code within a web browser in said client apparatus.

9. A method as claimed in claim 1 wherein:
said encoding c) activity encodes an identification of each of said plurality of service providers into said code; and
said generating f) activity generates at least one of said plurality of secondary requests for said each service provider having an identification encoded into said code in said encoding c) activity.

10. A method as claimed in claim 1 wherein:
said method additionally comprises queuing said plurality of requests in response to said executing e) activity; and
said dispatching g) activity dispatches said plurality of secondary requests to said plurality of service providers in response to said executing e) and queuing activities.

11. A method as claimed in claim 1 additionally comprising processing said plurality of responses within said client apparatus in response to said executing e) activity.

12. A method as claimed in claim 11 wherein:
said code comprises.
a first code; and
a second code;
said method additionally comprises:
i) initiating said second codes in said client apparatus a plurality of times in response to said executing e) activity; and
j) executing each of said plurality of second codes in said client apparatus in response to said initiating i) activity; and
said processing activity processes each of said plurality of responses in response to said executing j) activity.

13. A method as claimed in claim 1 additionally comprising submitting said plurality of responses to said encoding server in response to said executing e) activity.

14. A method as claimed in claim 1 additionally comprising aggregating said plurality of responses in response to said executing e) activity to form an aggregate response.

15. A method as claimed in claim 14 additionally comprising submitting said aggregate response to said encoding server.

16. A method as claimed in claim 14 wherein:
said code comprises:
a first code; and
a second code;
said method additionally comprises:
i) initiating said second code in said client apparatus in response to said executing e) activity; and
j) executing said second code in said client apparatus in response to said initiating i) activity; and
said aggregating activity aggregates said plurality of responses in response to said executing j) activity.

17. A method as claimed in claim 1 wherein said executing e) executes said code in a web browser in said client apparatus.

18. A method as claimed in claim 1 additionally comprising processing said plurality of responses to determine a ranking of a web site on the Internet.

19. A system of distributed information retrieval and processing, said system comprising:
a client apparatus configured to:
originate a primary request;
transmit said primary request;
receive code peculiar to said primary request;
execute said code;
generate a plurality of secondary requests in response to said code;
dispatch said plurality of secondary requests in response to said code; and
receive a plurality of responses to said plurality of secondary requests in response to said code;
an encoding server configured to:
receive said primary request from said client apparatus;
encode said code peculiar to said primary request; and
transmit said code to said client apparatus; and
a plurality of service providers configured to:
receive said plurality of secondary requests from said client apparatus;
generate said plurality of responses in responses to said plurality of secondary requests; and
transmit said plurality of responses to said client apparatus.

20. A system as claimed in claim 19 wherein:
said client apparatus is coupled to said encoding server via a communication network; and
said client apparatus is coupled to said plurality of service providers via said communication network.

21. A system as claimed in claim 20 wherein said first and second communication networks are the Internet.

22. A system as claimed in claim 19 wherein said client apparatus is additionally configured to provide said encoding server with information required to effect the encoding of said code peculiar to said primary request.

23. A system as claimed in claim 22 wherein said client apparatus provides said encoding server with said information when said information is not provided in said primary request.

24. A system as claimed in claim 22 wherein said encoding server is configured to alter said primary request in response to said information.

25. A system as claimed in claim 19 wherein said client apparatus is additionally configured to process said plurality of responses.

26. A system as claimed in claim 19 wherein:
said code comprises:
a first code; and
a second code;
said client apparatus is additionally configured to initiate said second code a plurality of times, and execute said plurality of second codes in response to said first code; and
said client apparatus is configured to process one of said plurality of responses in response to one of said plurality of second codes.

27. A system as claimed in claim 19 wherein said client apparatus is additionally configured to submit said plurality of responses to said encoding server.

28. A system as claimed in claim 19 wherein said client apparatus is additionally configured to:
aggregate said plurality of responses to form an aggregate response; and
submit said aggregate response to said encoding server.

29. A system as claimed in claim 28 wherein:
said code comprises:
a first code; and
a second code;
said client apparatus is additionally configured to initiate and execute said second code in response to said first code; and
said client apparatus is configured to aggregate said plurality of responses in response to said second code.

30. In a system of distributed information retrieval and processing, which system utilizes a client apparatus coupled to an encoding server via a communication network and coupled to a plurality of service providers via said communication network, a method of operating said client apparatus comprising:
originating a primary request;
transmitting said primary request to said encoding server via said communication network;
receiving code peculiar to said primary request from said encoding server via said communication network;
executing said code;
generating a plurality of secondary requests in response to said executing activity;
dispatching said plurality of secondary requests to said plurality of service providers via said communication network in response to said executing activity, wherein said dispatching activity dispatches at least one of said plurality of secondary requests to each of said plurality of service providers; and
receiving a plurality of responses from said plurality of service providers via said second communication network.

31. A method as claimed in claim 30 additionally comprising coordinating said primary request with said encoding server via said first communication network.

32. A method as claimed in claim 30 wherein said coordinating activity comprises providing said encoding server with information required of said encoding activity via said communication network.

33. A method as claimed in claim 30 additionally comprising processing said plurality of responses in response to said executing activity.

34. A method as claimed in claim 30 additionally comprising submitting said plurality of responses to said encoding server via said communication network.

35. A method as claimed in claim 30 additionally comprising aggregating said plurality of responses in response to said executing activity to form an aggregate response.

36. A method as claimed in claim 30 additionally comprising submitting said aggregate response to said encoding server via said first communication network.

37. In a system of distributed information retrieval and processing, which system utilizes a client apparatus coupled to an encoding server via a communication network and coupled to a plurality of service providers via said communication network, a method of operating said encoding server comprising:
receiving a primary request from said client apparatus via said first communication network;
coordinating said primary request with said client apparatus via said first communication network;
encoding code peculiar to said primary request; and
transmitting said code to said client apparatus via said first communication network, wherein said code is configured to:
execute upon said client apparatus;
generate a plurality of secondary requests in response to said execution;
dispatch said plurality of secondary requests from said client apparatus to said plurality of service providers in response to said execution; and
receive a plurality of responses from said plurality of service providers at said client apparatus in response to said execution.

38. A method as claimed in claim 37 wherein said coordinating activity comprises:
transmitting a request for information required of said encoding activity and not contained in said primary request to said client apparatus via said communication network;
receiving said information from said client apparatus via said communication network; and
altering said primary request in response to said receiving activity.

39. A method as claimed in claim 37 wherein said coordinating activity comprises:
determining if said primary request lacks information required of said encoding activity;
transmitting a request for said information when said determining activity determines said primary request lacks said information to said client apparatus via said first communication network;
receiving said information from said client apparatus via said first communication network; and
altering said primary request in response to said receiving activity.

40. A method as claimed in claim 37 additionally comprising receiving said plurality of responses from said client apparatus via said first communication network.

41. A method as claimed in claim 37 additionally comprising receiving an aggregate response from said client apparatus via said first communication network, wherein said aggregate response is an aggregation of said plurality of responses.

42. A method of distributed information retrieval and processing utilizing a client apparatus, an encoding server, and a plurality of service providers mutually coupled via a communication network, said method comprising:
receiving a primary request via said communication network;
coordinating said primary request over said communication network;
encoding code peculiar to said primary request;
transmitting said code via said communication network;
executing said code;
generating a plurality of secondary requests in response to said executing activity; and
dispatching said plurality of secondary requests via said communication network in response to said executing activity.

43. A method as claimed in claim 42 wherein:
said receiving activity receives said primary request at said encoding server from said client apparatus;
said coordinating activity coordinates said primary request between said client apparatus and said encoding server;
said encoding activity encodes said code within said encoding server;
said transmitting activity transmits said code from said encoding server to said client apparatus;
said executing activity executes said code within said client apparatus;
said generating activity generates said plurality of secondary requests within said client apparatus; and
said dispatching activity dispatches said plurality of secondary requests from said client apparatus to said plurality of service providers.

44. A method as claimed in claim 42 wherein said coordinating activity comprises:
providing information required of said encoding activity prior to said encoding activity via said communication network; and
altering said primary request in response to said providing activity.

45. A method as claimed in claim 42 additionally comprising:
receiving a plurality of responses via said communication network in response to said executing activity; and
processing said plurality of responses in response to said executing activity.

46. A method as claimed in claim 45 wherein:
said receiving activity receives said plurality of responses at said client apparatus from said plurality of service providers; and
said processing activity processes said plurality of responses within said client apparatus.

47. A method as claimed in claim 45 additionally comprising submitting said plurality of responses to said encoding server via said communication network.
